(19) United States
(12) Patent Application Publication
(10) Pub. No.: US 2006/0146027 A1
(43) Pub. Date: Jul. 6, 2006

(54) Keypad and button mechanism having enhanced tactility

(76) Inventors: James L. Tracy, Coral Springs, FL (US); James A. Zollo, Weston, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/027,268

(22) Filed: Dec. 31, 2004

(51) Int. Cl. G09G 5/00

(52) U.S. Cl. 345/168

(57) ABSTRACT

A keypad assembly for an electronic device where characters are displayed on the buttons has a flexible display laminate (105). The flexible display laminate has a driver layer (106) on which button regions of conductor (300) are formed. Surrounding the button regions are conductorless regions (312). The lack of conductor in the surrounding regions allows appropriate tactile feedback to a user when the user depresses an actuating member (112), through which character formed by the flexible display laminate may be seen, actuating a popple switch circuit which allows the device to detect the button press.

### TECHNICAL FIELD

This invention relates in general to keypads and button mechanisms for handheld electronic devices, and more particularly to keypads having buttons which display information on the buttons.

### BACKGROUND OF THE INVENTION

Electronic devices are in widespread use throughout the world, and portable electronic devices such as cellular radio telephones and personal data organizers are also increasingly common in metropolitan regions. It is not uncommon for a person to have several of these devices where each device performs a different task. From a user's perspective, it would be much more convenient to have such devices integrated into one device. Integration would eliminate having to maintain separate accessories, batteries, and so on, and carrying one device is more convenient than carrying several devices for separate functions. One problem that has arisen in considering ways to integrate such devices into one device is the ergonomics of the user interface. For example, users have come to expect a cellular radio telephone to have a numeric keypad, with several alphabetic characters available on the digit keys for text entry. Conversely, users of so called two-way pagers and palm-top computers are accustomed to more conventional “QWERTY” keypads, having a layout similar to that of a computer keyboard and typewriters.

Manufacturers of electronic devices often manufacture the devices for sale in more than one world market, and consequently often have different keypads or buttons made with language or characters corresponding to the language prevalent in a particular region. This necessitates having an inventory of different parts for keypads and button, as well as maintaining separate “kits” for tracking the devices once they are assembled to assure the right kit goes to the intended market.

It would be of substantial benefit if, on an integrated device that performs several functions, the keypad and buttons could adapt, and change their appearance, so as to provide a familiar interface to the user. Similarly, if a keypad or button could change it's appearance, then the same keypad could be used for different language markets, and it would simply display the appropriate characters or symbols. That is, if the keypad were adaptable, a common keypad sub-assembly could be used, thereby eliminating the need for manufacturing and stocking different keypad parts for different language markets. Having different characters or symbols displayed on various keys or buttons would be possible using conventional display technology, such as liquid crystal displays, one on each button. However this approach suffers from being prohibitively expensive, and LCD displays are not flexible, so they would not be optimal for use with inexpensive popple switch type keypads commonly found on portable electronic device.

A flexible and adaptable keypad assembly is shown in U.S. patent application Ser. No. 10/055474, titled “Adaptable Keypad And Button Mechanism Therefore,” and which is commonly assigned with the present application. There, a flexible display layer is situated beneath transparent button members so that different characters maybe displayed on the button. The display layer uses a direct drive backplane, meaning the character or characters that may be displayed on a given button are fixed, and the backplane has metallization in the shape of the character or symbol to be displayed etched on it to generate a corresponding shape in a display medium, such an a electrically active ink layer, disposed adjacent the backplane. However, even though the display layer described there is flexible, users of portable devices have become accustomed to a certain degree of tactile feedback from buttons and keypads on portable devices. As such, if the tactile feedback is too soft, or the button mechanism too rigid, users tend to find it to be difficult to operate. Therefore a means of providing an appropriate tactile response of a button or keypad using a flexible display is needed.

### BRIEF DESCRIPTION OF THE DRAWINGS

FIG. 1 shows a side cross section view of a button mechanism, in accordance with an embodiment of the invention.;

FIG. 2 shows an exploded isometric view of an adaptable keypad assembly having enhanced tactility, in accordance with an embodiment of the invention;

FIG. 3 shows a button region of the driver layer of an adaptable keypad assembly for enhancing tactility, in accordance with an embodiment of the invention; and

FIG. 4 shows a side cross section of a flexible display laminate, in accordance with an embodiment of the invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward.

The invention solves the problem of suboptimal tactile feedback of keypads using a flexible display behind the buttons to display information at, or visibly through the buttons by reducing the rigidity of the flexible display in the areas of the button. In particular, the backplane or driver layer of the display is altered by removing metallization in regions around the button regions. Sufficient metallization is retained in the button region that is visible to the user so that the electrophoretic material visible in the button region can be electrically affected to form the desired character at each button. The result is an “island” of metallization, divided into appropriate segments in the button region visible to the user. The absence of metallization outside the visible button regions enhances the flexibility of the display layer by allowing unrestrained relative movement during individual button presses without affecting the un-deflected position of the adjacent character regions.

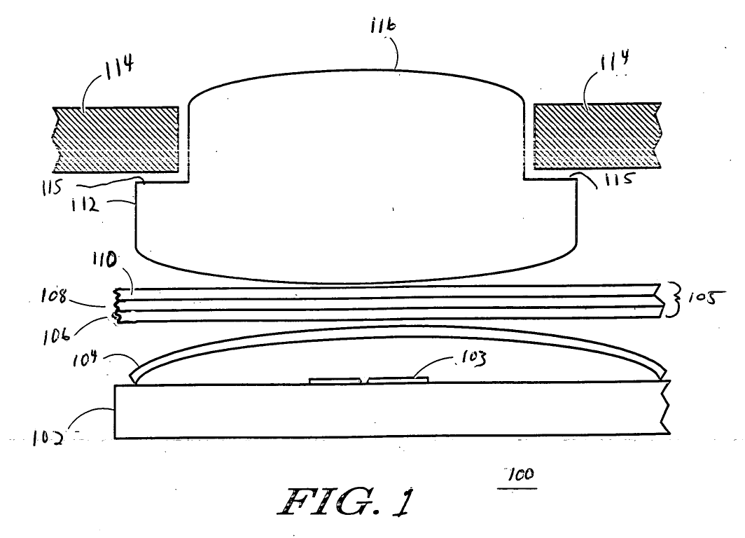

Referring now to FIG. 1, there is shown a side cross section view of a button mechanism 100, in accordance with the invention. The button mechanism shown here is compatible for use with a multitude of hand held electronic devices. In the present embodiment of a button mechanism, the mechanism utilizes a button circuit board 102 and popple dome 104 design, as is common. The button circuit board may be a conventionally fabricated printed circuit board, such as a rigid circuit board, or it may be a flexible circuit board, and has on it a switch circuit 103, which may be a two-part conductor pattern electrically connected to control circuitry for detecting when the popple dome 104 comes into contact with the switch circuit, electrically coupling both parts of the conductor pattern. The popple dome is a dome structure fabricated of electrically conductive material, and has a spring quality so that it may be deflected under pressure, returning to its dome shape when the pressure is removed. When the popple dome is depressed, it comes into contact with the switch circuit 103 and completes an electrical circuit, which is detected by control circuitry, as is conventional.

Disposed in correspondence with the switch means is the flexible display laminate 105, comprised of a driver layer 106, an electrically active ink layer 108, and a transparent conductor layer 110. The electrically active ink layer is disposed between the driver layer and transparent conductor layer. The driver layer is a direct drive backplane, meaning the symbols or characters to be displayed are generated by conductor elements formed on the driver layer in the shape of the characters or symbols to be displayed. Furthermore, it is contemplated that an active matrix of conductor elements may be used to form characters by activating pixels in the form of the desired character or symbol.

The button mechanism could function with just the display laminate and popple switch, but in the preferred embodiment, the button mechanism further comprises a transparent actuating member 112 disposed in correspondence with the popple switch, such that the display means is between the popple switch and the transparent actuating member. The transparent actuating member contacts the display laminate and is held in place by the housing 114 of the device in which the button is situated. The actuating member may be provided with a shoulder 115 so that the housing can captivate and hold the actuating member in place. It is contemplated that the transparent actuating member may have a convex outer surface 116 to provide a magnifying effect, as well as tactile differentiation from the device housing. Furthermore, it is contemplated that the transparent actuating member may have a concave outer surface to focus reflected light to enhance viewing of the information displayed at the button by the flexible display.

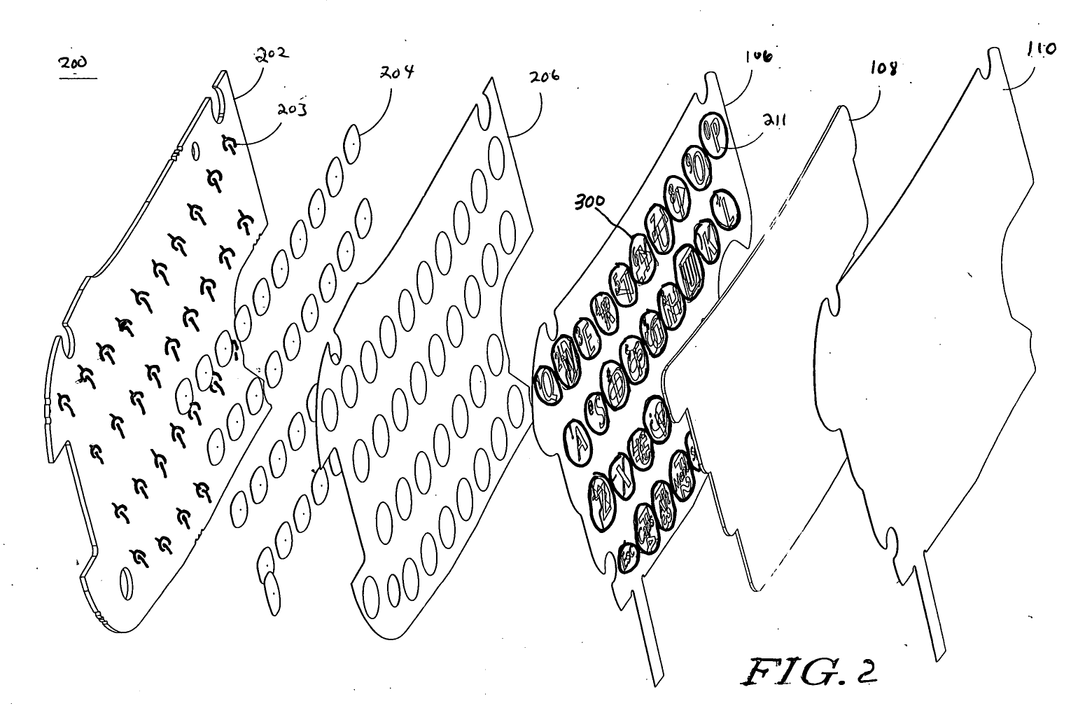

Referring now to FIG. 2, there is shown an exploded isometric view of an adaptable keypad assembly 200. The adaptable keypad assembly comprises a plurality of button mechanisms such as that shown in FIG. 1, where the button circuit board and display laminate are shared among a plurality of buttons. The adaptable keypad assembly comprises a button circuit board 202 having a series of switch circuits 203 disposed thereon, a plurality of popple domes 204 aligned in correspondence with the switch circuits on the button circuit board, and an adhesive layer 206 for holding the popple domes in place. The keypad may be adaptable so that the information displayed on each button can be changed by selectively electrifying driver elements on the driver layer 106 of the display laminate. The adaptable keypad assembly may therefore be used in handheld devices which operate in different modes, or use different languages. The display laminate is comprised of the driver layer 106, an electrically active ink layer 108, and a transparent conductor layer 110. The driver layer 106 is itself a laminate comprised of a flexible insulator layer made of, for example, Mylar or polyimide. On the flexible insulator layer there is disposed metalized button regions, such as regions 211 and 300, which are comprised of conductor elements. The conductor elements include character segments for forming characters or symbols, and blanking segments for providing a contrasting field around the character segments to further define, visually, characters and symbols to be displayed. Outside of the button regions metallization is not present so as to decrease the rigidity of the display laminate outside of the button regions. There are also conductive traces connected to the conductive elements for providing voltage or otherwise electrically energizing the conductor elements. These traces may be on the same side of the flexible insulator, or they may be located on another side or inside the flexible substrate, and pass through the flexible insulator by, for example, electrically conductive via holes, as is known.

The electrically active ink layer is an electrophoretic material, and comprises, for example, bi-chromal microspheres having an electrical polarity, suspended in medium that allows the microspheres to freely rotate. An example of an electrically active ink is shown in U.S. Pat. No. 6,120,588, assigned to E-Ink Corporation. The microspheres, being electrically polarized, rotate when a voltage differential is applied to them. Selectively applying voltage differential at various points on the layer causes the microspheres at those points to rotate, and being bi-chromal, show a different color at that point. The voltage differential is experienced between the conductor elements and the transparent conductor layer 112. The transparent conductor lay is a layer of, for example, indium tin oxide. The entire layer can be set to one voltage potential, while the conductor elements are set to a different voltage potential, thus creating an electric field between the transparent conductor layer and the conductor elements which will cause the bi-chromal polarized microspheres in the field to rotate accordingly. Initially all of the bi-chromal polarized microspheres will be commonly oriented. When the conductor elements and the transparent conductor layer are electrically energized, the spheres between them will rotate, causing the region of electrically active ink between the conductor elements and the transparent conductor layer to appear to change color in a pattern corresponding with the pattern of the conductor elements. Once rotated, the field can be removed, and the microspheres hold their orientation. To erase the pattern, a field having the opposite polarity is applied, causing the spheres to rotate to their initial position.

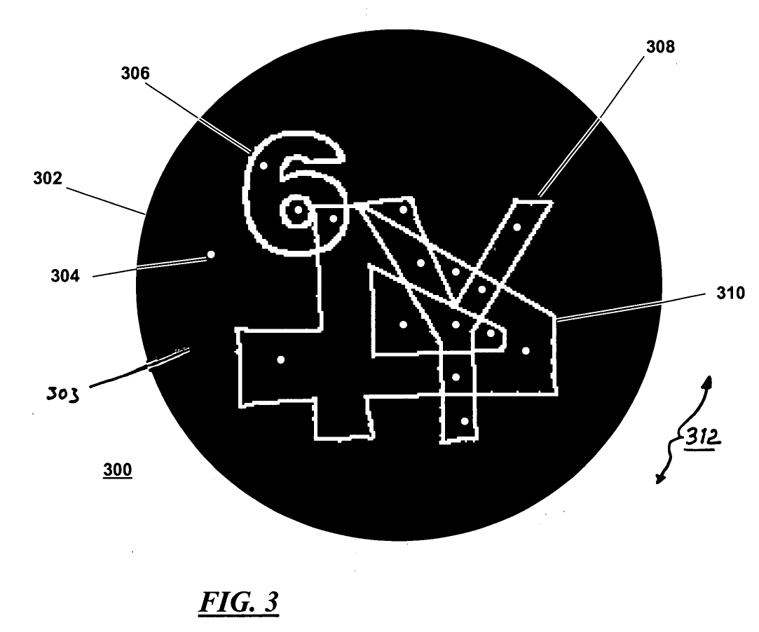

Referring now to FIG. 3, there is shown a button region 300 of the driver layer of an adaptable keypad assembly for enhancing tactility, in accordance with an embodiment of the invention. The button region may be formed in the shape of the button and actuating member 112. The button region's shape corresponds to the shape of the button, and may be circular as shown, or formed in whatever shape in which the button is formed. The button region of the driver layer is conductive material 302, such as plated copper, for example, as is common in the construction of printed and flexible circuit boards. To form characters in the electrically active ink layer adjacent the driver layer, conductor elements in the form of character segments of the driver layer may be selectively electrified, causing a change in orientation, for example, of the bi-chromal microspheres of the electrically active ink layer. Electric potentials may be selectively applied to the various blanking segments 303 and character segments 306, 308, 310 of the button region by the use of a electrically conductive via 304 in each segment. For the particular button region shown, the button is designed to display three different characters, depending on the operating mode of the device. A “6” 306, “Y” 308, and “4” 310 can be seen, each character being formed of a plurality of character segments, and each character segment with its own electrically conductive via. The electrically conductive vias are connected to an adjacent layer of conductor runners, which are connected to a driver circuit so that each segment group may be electrified. The conductor elements not used to form the likeness of a character or symbol is the blanking segment or segments. In embodiments where multiple characters may be displayed on a button, as shown here, the inactive character segments may be used as blanking segments around the character elements that are presently active.

The button region may be designed to display a single character or a plurality of characters, each of which is displayed at a different time, and related to an operating mode of the device, for example. The characters may be oriented differently to correspond with the device being operated in different orientations in different modes. The button region is surrounded by conductorless region 312. The conductorless region may be a complete lack of conductor, or it may be substantially conductorless where, for example, only conductor traces connect to conductor elements in the button region. The lack of conductor around the button region permits the flexible display laminate to flex with less force than had the driver layer been entirely plated with conductor in the regions between the button regions. Easier flexing provides more tactile feedback to the user's finger when depressing the button and popple dome. The conductor in the button region not used to form a character, referred to as the blanking segment or elements, provides contrast so that the character being displayed may be seen. It is contemplated, in an alternative embodiment, that the non-character conductor of a button region may be linked to adjacent button regions since the conductor outside the button regions may not be visible through the housing 114 of the device.

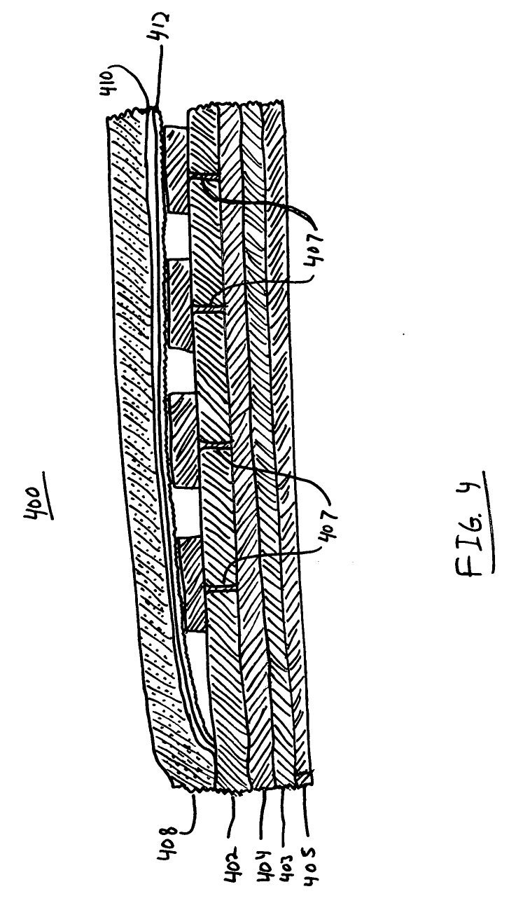

Referring now to FIG. 4, there is shown a side cross section 400 of a flexible display laminate, in accordance with an embodiment of the invention. The flexible display laminate includes a flexible insulator substrate layer 402. On a bottom or outside surface of the flexible substrate layer 402 is a conductor layer 404 for supplying voltage to conductive elements on a conductive element layer 406. The conductive element layer includes conductive elements for forming the characters or symbols to be displayed. The conductive elements are electrically connected to the conductor layer 404 by electrically conductive vias 407. On top of the conductive elements is a cover layer 408 formed of a transparent flexible insulator substrate. On the back of the transparent cover layer is a transparent conductor layer 410, such as indium tin oxide. Between the transparent conductor layer 410 and the conductive elements 406 is the electrophoretic material 412. The edges of the flexible display laminate may be sealed in a conventional manner. Furthermore, the flexible display laminate comprises a flexible insulator layer 403 as a backing, to protect the conductor layer 404, and a vapor barrier layer 405 formed of conductor may also be used. The vapor barrier layer is not electrically coupled to any signal or voltage potential, and is for further environmental protection of the flexible display laminate.

Therefore the invention provides a button assembly for an electronic device having a flexible display laminate for displaying a character to be displayed at the button, and a transparent actuating member disposed over the flexible display laminate. The actuating member is the part of the button mechanism on which the user presses, thereby moving a spring switch means disposed beneath the flexible display laminate into contact with a switch circuit, which the electronic device detects. Furthermore, the flexible display laminate has a direct drive backplane including conductor elements for defining the character to be displayed disposed at the button region, and the button region is surrounded by a conductorless region. The lack of conductor around the button region allows flexing of the flexible display laminate in a manner that provides more tactile feedback to the user than when the driver layer is fully metalized. In one embodiment of the invention the spring switch means is a popple dome. Alternatively, other spring switch types may be used, such as, for example, a spiral spring and plunger arrangement.

The conductor elements in the button region include blanking segments and character segments. The blanking segments are used to provide contrast in the display medium of the flexible display laminate. The display medium may be an electrophoretic material. The button region may include character segments for multiple characters. Typically only one character may be displayed at a time, and other character segments are inactive and used as blanking segments to define the character being displayed. It is further contemplated that at least two of the multiple characters may overlap and have common character segments.

The invention further provides a keypad assembly for an electronic device. The keypad assembly includes a rigid printed circuit board. On the button circuit board there is a plurality of switch circuits, and each one of the switch circuits is located at a button position. Also located at each button position is one of a plurality of popple domes for electrically activating the switch circuits when pressed into contact with the popple dome's corresponding switch circuit. The assembly further includes a flexible display laminate having a plurality of button regions. Each of the button regions is located in correspondence with a button position. The keypad assembly further includes a plurality of actuating members. Each of the actuating members is disposed over one of the button regions, and is for actuating a corresponding popple dome. The actuating members are transparent so that a character or symbol to be displayed on the flexible display laminate may be seen therethrough. The flexible display laminate has a driver layer on which conductor elements is surrounded by a conductorless region. It is contemplated that the conductorless regions of the flexible display laminate are hidden from view by a housing of the electronic device, and wherein the housing holds the plurality of actuating members in place.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A flexible display laminate for use with an electronic device, comprising:
an electrically active ink layer;
a transparent conductor layer disposed over the electrically active ink layer; and
a driver layer having at least one button region comprised of a plurality of conductor elements, and wherein the at least one button region is surrounded by a conductorless region to allow flexing of the flexible display laminate at the button region for providing tactile feedback of a switch disposed in correspondence with the button region.

2. A flexible display laminate as defined in claim 1, wherein the plurality of conductor elements includes blanking segments and character segments.

3. A flexible display laminate as defined in claim 2, wherein the at least one button regions comprises character segments for multiple characters, where only one character of the multiple characters may be displayed at a time, and other character segments are inactive and used as blanking segments.

4. A flexible display laminate as defined in claim 3, wherein at least two of the multiple characters overlap and have common character segments.

5. A button assembly for an electronic device, comprising:
a flexible display laminate for displaying a character to be displayed at the button;
a transparent actuating member disposed over the flexible display laminate and defining a button region of the flexible display laminate; and
a spring switch means disposed beneath the flexible display laminate in correspondence with the button region for activating a switch circuit when the transparent button member is actuated;
wherein the flexible display laminate has a backplane comprising conductor elements for defining the character to be displayed, and wherein the button region is surrounded by a conductorless region.

6. A button assembly as defined in claim 5, wherein the spring switch means comprises a popple dome.

7. A button assembly as defined in claim 5, wherein the conductor elements in the button region include blanking segments and character segments.

8. A button assembly as defined in claim 7, wherein the button region comprises character segments for multiple characters, where only one character of the multiple characters may be displayed at a time, other character segments are inactive and used as blanking segments.

9. A button assembly as defined in claim 8, wherein at least two of the multiple characters overlap and have common character segments.

10. A keypad assembly for an electronic device, comprising:
a button circuit board having a plurality of switch circuits disposed thereon, each one of the plurality of switch circuits located at a button position;
a plurality of popple domes, each one of the plurality of popple domes disposed over one of the plurality of switch circuits, and for electrically activating the switch circuits;
a flexible display laminate having a plurality of button regions, each of the plurality of button regions located in correspondence with a button position; and
a plurality of actuating members, each of the plurality of actuating members disposed over one of the button regions and for actuating one of the plurality of popple domes, each of the plurality of actuating members being transparent so that a character to be displayed on the flexible display laminate may be seen;
wherein the flexible display laminate includes a driver layer on which conductor elements are disposed in each one of the plurality of button regions, and wherein each one of the plurality of button regions on the driver layer are surrounded by a conductorless region.

11. A keypad assembly as defined in claim 10, wherein the conductorless regions of the flexible display laminate are hidden from view by a housing of the electronic device, and wherein the housing holds the plurality of actuating members in place.

12. A keypad assembly as defined in claim 10, wherein the conductor elements in the button region include blanking segments and character segments.

13. A keypad assembly as defined in claim 12, wherein at least one of the plurality of button regions comprises character segments for multiple characters, where only one character of the multiple characters may be displayed at a time, other character segments are inactive and used as blanking segments.

14. A keypad assembly as defined in claim 13, wherein at least two of the multiple characters overlap and have common character segments.
